(19) United States
(12) Patent Application Publication
(10) Pub. No.: US 2021/0131936 A1
(43) Pub. Date: May 6, 2021

(54) THERMAL ANALYZER

(71) Applicant: SHIMADZU CORPORATION, Kyoto-shi (JP)

(72) Inventors: Hajime TOMITA, Kyoto-shi (JP); Kiminori Sato, Kyoto-shi (JP); Satoshi Shimizu, Kyoto-shi (JP); Kaori Nishibata, Kyoto-shi (JP)

(73) Assignee: SHIMADZU CORPORATION, Kyoto-shi (JP)

(21) Appl. No.: 17/038,271

(22) Filed: Sep. 30, 2020

(30) Foreign Application Priority Data
Nov. 1, 2019 (JP) 2019-199809

(51) Int. Cl. G01N 5/04; G01N 25/48

(52) U.S. Cl. CPC G01N 5/04; F27B 17/02; G01N 25/4866

(57) ABSTRACT

A thermal analyzer includes heating section including a heating furnace in which a sample is contained, and a weight measurement section configured to measure a weight of the sample. The weight of the sample is measured by the weight measurement section while the sample is heated by the heating section. The thermal analyzer further includes: a light emitting indicator that is provided in front of the exterior of the thermal analyzer, and includes a plurality of light emitting diode elements; an analysis controller configured to control heating by the heating section in accordance with a predetermined measurement program, and to acquire weight data of the sample from the weight measurement section in a predetermined time period; and an indication controller configured to drive the light emitting indicator to flash at least during a time period in which the weight data is acquired.

### TECHNICAL FIELD

The present invention relates to a thermal analyzer, such as a differential thermal analyzer and a thermogravimetric apparatus.

### BACKGROUND ART

Thermal analysis is performed through various methods including differential thermal analysis, thermogravimetry, thermomechanical analysis, and differential scanning calorimetric analysis. In the differential thermal analysis, for example, a specimen sample and a reference sample are made to undergo thermal changes in accordance with a certain program while the temperature difference between the specimen sample and the reference sample is measured as a function of temperature. Transition, melting, reaction, and other phenomenon accompanying endothermic and exothermic reactions are observed in the measurement. Meanwhile, the thermogravimetry is a method of measuring the change in weight of a sample while the sample is heated or cooled at a constant rate, or when the sample is held at a constant temperature. Chemical or physical change that accompanies the weight change with respect to temperature is observed in the thermogravimetry. Examples of the chemical and physical changes include vaporization, decomposition, oxidation, reduction, and adsorption.

For example, an apparatus which has the function of both differential thermal analysis and thermogravimetric analysis, and can simultaneously perform these analyses is disclosed in Non Patent Literature 1. FIG. 4 is a perspective view of a thermogravimetric/differential thermal analysis (TG/DTA) simultaneous measurement apparatus disclosed in Non Patent Literature 1. The arrow in FIG. 4 indicates the front of the apparatus. This apparatus includes: a weight measurement section for measuring the respective weights of a specimen sample and a reference sample, inside a casing 103 located in the lower part of the apparatus; a heating furnace section 101 in which a heating furnace for heating the specimen sample and the reference sample is housed, on top of the casing 103; and a heating furnace moving section 102 for moving the heating furnace section 101 upward and downward, behind the heating furnace 101. Behind the heating furnace moving section 102, a controller 5 containing various electric circuits is housed in the apparatus. Furthermore, an operation panel 106 in which a liquid crystal display (LCD) serving as a user interface, a light emitting diode (LED), a switch, and the like are disposed is provided at a lower portion in the front surface of a housing.

The LED provided in the operation panel 106 serves as a so-called ON/OFF indicator that indicates an activation state and a halt state of the apparatus. The LCD is an indicator that can indicate numerical values of temperature, weight, electromotive force, and others selectively by switching. The switch is used for turning the apparatus on and off and changing the information to be displayed on the LCD.

### CITATION LIST

### Non Patent Literature

Non Patent Literature 1: “DTG-60/60H series, TG/DTA simultaneous measuring instrument”, [website], Shimadzu Corporation, (searched on Aug. 6, 20191, Internet

### SUMMARY OF INVENTION

### Technical Problem

In the weight measurement section of a thermal analyzer, such as the aforementioned TG/DTA simultaneous measurement apparatus, it is necessary to measure an extremely tiny sample having a weight at a level of microgram. In such precise measurements, an extremely small vibration may be a major factor of lowering the measurement accuracy. Even an individual's walk around an apparatus may disturb the measurement. Accordingly, it is preferable to prevent users from being near the apparatus during the measurement, not to mention to prevent users from touching the apparatus, including operating switches, or the installation stand of the apparatus.

Although the ON/OFF state of the apparatus is indicated in the aforementioned conventional TG/DTA simultaneous measurement apparatus, the indication is not so noticeable. Furthermore, even when the apparatus is in the ON state, the measurement is not always in process. Thus, users often touched the installation stand or walked around the apparatus without being aware of the running measurement. Since a measurement relatively takes time, the measurement is often carried out during night hours or holidays in an automatic manner. However, some security staff who made patrol came close to the apparatus or touched the apparatus without noticing that the apparatus was operating. If weight data is disturbed by such disturbances, the measurement has to be carried out again. This causes the measurement efficiency to be lowered and the measurement cost to increase.

The present invention has been made for solving such problems. The main purpose of the present invention is to provide a thermal analyzer that prevents weight data from being disturbed by a disturbance during the measurement, and improves the measurement efficiency.

### Solution to Problem

The present invention developed for solving the previously described problems is a thermal analyzer including: a heating section including a heating furnace in which a sample is contained; and a weight measurement section configured to measure a weight of the sample, the weight of the sample being measured by the weight measurement section while the sample is heated by the heating section. The thermal analyzer further includes: a light emitting indicator that is provided in front of the exterior of the thermal analyzer, and includes a plurality of light emitting diode elements; an analysis controller configured to control heating by the heating section in accordance with a predetermined measurement program, and to acquire weight data of the sample from the weight measurement section in a predetermined time period; and an indication controller configured to drive the light emitting indicator to flash at least during a time period in which the weight data is acquired.

### Advantageous Effects of Invention

According to the thermal analyzer of the aforementioned aspect of the present invention, the light emitting indicator flashes while the measurement is carried out to actually collect the weight data, but not while the apparatus is merely activated (or in an energized state). The flash indication is easily noticeable in comparison with a simple light-up indication, so as to be effective in drawing the operator's attention. In addition, the light emitting indicator includes a plurality of light emitting diode elements, so as to have a wide light emission area or a long light emission region. Therefore, high visual noticeability can be ensured even from a location relatively apart from the apparatus.

In the thermal analyzer according to the aspect of the present invention, a user (operator) apart to some extent from the apparatus can easily recognize that the measurement is in process in the apparatus. Therefore, the operator can be appropriately prevented from touching the apparatus itself or an installation stand of the apparatus, and from carelessly approaching the device. As a result, defects of the weight measurement due to disturbance can be reduced, and necessity of retry of the measurement can be reduced, whereby the measurement efficiency can be improved. Furthermore, the lead time for the measurement can be shortened.

### BRIEF DESCRIPTION OF DRAWINGS

FIG. 1 is a schematic block diagram showing configuration of a control system of a TG/DTA simultaneous measurement apparatus according to an embodiment of the present invention.

FIG. 2 is an explanatory diagram of an example of the indication in which the measurement is carried out in the TG/DTA simultaneous measurement apparatus according to the present embodiment.

FIGS. 3A and 3B are respectively a top view and a side view, each showing the exterior of the TG/DTA simultaneous measurement apparatus according to the present embodiment,

FIG. 4 is a perspective view of the exterior of a conventional TG/DTA simultaneous measurement apparatus.

### DESCRIPTION OF EMBODIMENTS

Hereinafter, a TG/DTA simultaneous measurement apparatus according to an embodiment of the present invention is described, with reference to the drawings.

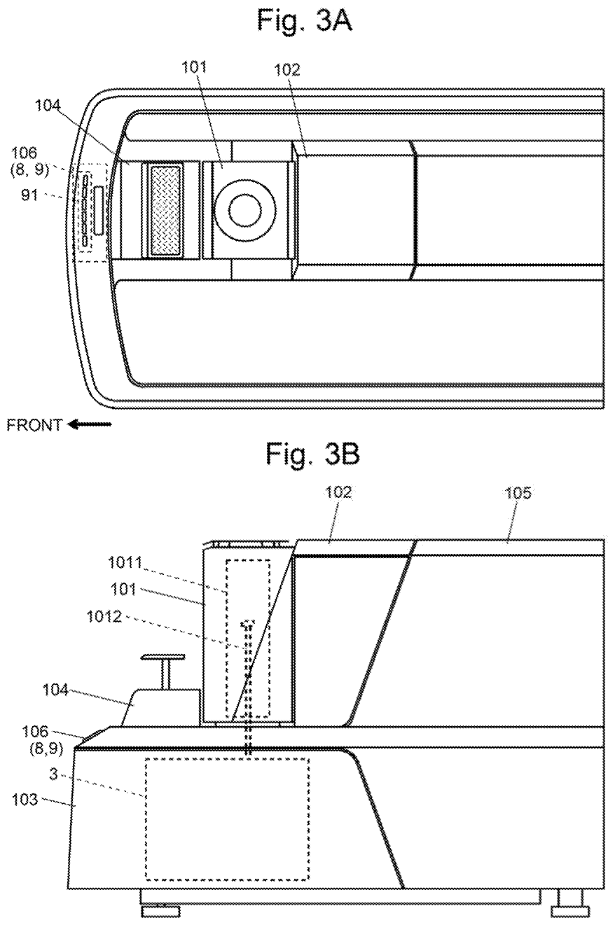

FIGS. 3A and 3B are plane views and are respectively a top view and a side view, each showing the TG/DTA simultaneous measurement apparatus according to the present embodiment.

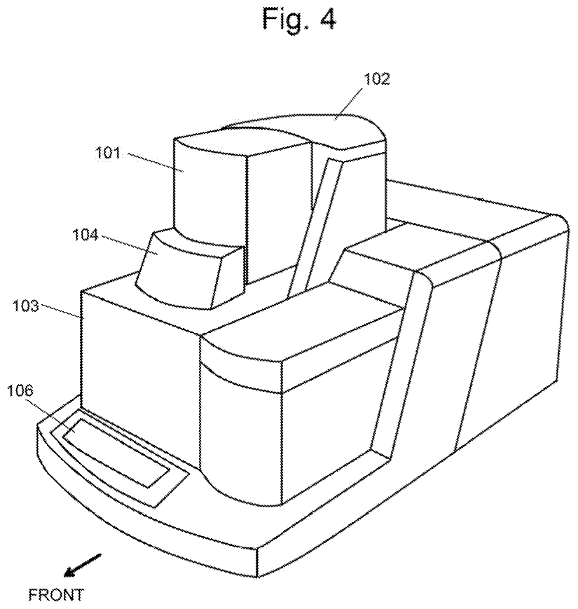

The TG/DTA simultaneous measurement apparatus according to the present embodiment is slightly different from the conventional apparatus shown in FIG. 4 in the exterior design, but is similar to the conventional one in the basic arrangement of each section. Specifically, the TG/DTA simultaneous measurement apparatus according to the present embodiment includes: in the lower part, a casing 103 in which a weight measurement section 3 for measuring the respective weights of a specimen sample and a reference sample are contained; above the casing 103, a heating furnace section 101 in which a heating furnace 1011 is housed; and behind the heating furnace section 101, a heating furnace moving section 102 for moving the heating furnace section 101 upward and downward. Behind the heating furnace moving section 102, various electric circuits including a controller (which will be described later) are contained. In the protruding portion in front of the heating furnace section 101 above the casing 103 in which the weight measurement section 3 is contained, there is provided a cooling section 104 which includes a fan for cooling a connecting portion that connects the bottom of the heating furnace 1011 and the weight measurement section 3.

In the interior of the heating furnace 1011, two detectors 1012 stand. In the top of each detector 1012, a sample plate on which a specimen sample or a reference sample is placed is provided. When the heating furnace 101 is moved upward to a predetermined position by the heating furnace moving section 102, the two detectors 1012 are exposed. In this state, a specimen sample and a reference sample can be placed on the sample plates. The sample plate is made of metal, such as platinum, for example, on the rear face of which a thermocouple for measuring the temperature is welded. A conduction wire of the thermocouple is guided through each of the detectors 1012 to be connected to a temperature measurement section (which will be described later). An operation panel 106 is disposed on the surface of the housing, which is oriented obliquely upward, in front of the cooling section 104.

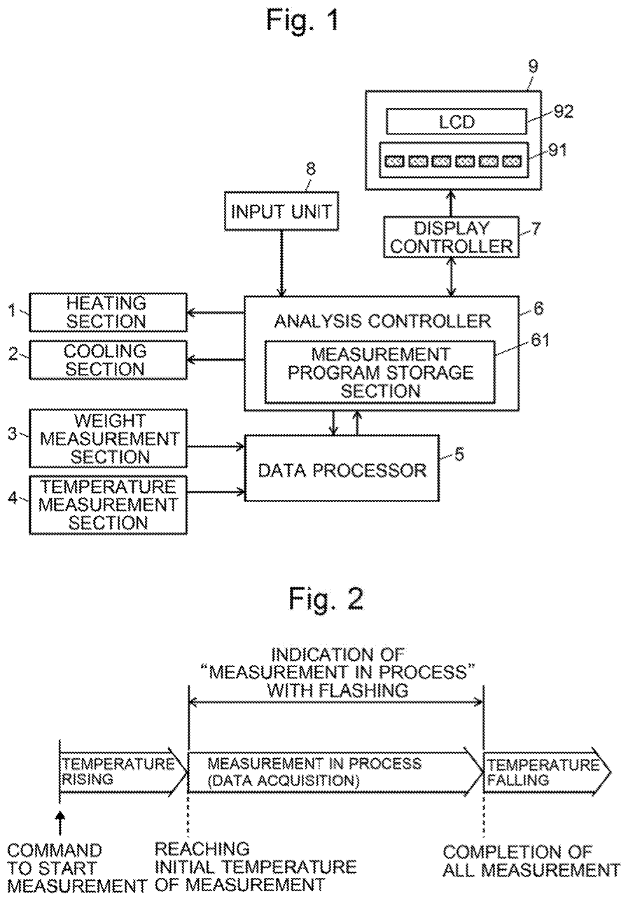

FIG. 1 is a schematic block diagram showing the configuration of a control system of the TG/DTA simultaneous measurement apparatus according to the present embodiment. FIG. 2 is an explanatory diagram of an example in which the measurement is carried out in the TG/DTA simultaneous measurement apparatus according to the present embodiment.

As shown in FIG. 1, the TG/DTA simultaneous measurement apparatus includes: a heating section 1 including the heating furnace 1011; a cooling section 2; a weight measurement section 3; a temperature measurement section 4; a data processor 5; an analysis controller 6; a display controller 7; an input unit 8; and a display unit 9. The heating section 1 includes a heater wire provided in the heating furnace 1011 and a current supply section for supplying heating current to the heater wire. The cooling section 2 may include a fan, and a cooling mechanism in which liquid nitrogen or the like is used, for example. The analysis controller 6 includes a measurement program storage section 61 in which a measurement program inputted by a user is stored. The input unit 8 and the display unit 9 are provided on the operation panel 106, and the display unit 9 includes an apparatus-state indicator 91 and an LCD 92. The apparatus-state indicator 91 includes a plurality of (six in this embodiment) LEDs arranged approximately straight in the horizontal direction, and has a total length of 50 mm or more. A plurality of LED elements are thus arranged, whereby the indication can be made noticeable even from a relatively remote location while the cost is controlled and space is minimized, unlike the case where a surface emission type LED, for example, is used.

The work and operation required in the measurement using the TG/DTA simultaneous measurement apparatus according to the present embodiment, and the operation of the apparatus are described.

When an operator turns on the power by a power switch (not shown), the apparatus is activated. The operator places a specimen sample and a reference sample on sample plates inside the heating furnace 1011, sets an appropriate measurement program, and then issues a command to start the measurement.

When receiving the command to start the measurement, the analysis controller 6 reads the measurement program from the measurement program storage section 61, and starts, for example, to cause the heating section 1 to increase the temperature, in accordance with the program. The temperature measurement section 4 sends, moment by moment, measurement values of the temperatures of a specimen sample (and a reference sample) to the data processor 5, from the time point at which the temperature starts rising. In some measurement programs, the measurement of the weight of a sample may start at the time point when the temperature starts rising. In typical cases, however, as shown in FIG. 2, the temperature of the sample is raised to a predetermined initial temperature, and the weight measurement starts at this point. In this case, a time period for the temperature of the sample to reach the initial temperature is a preparatory period for the measurement. During the preparatory period, the display controller 7 keeps the apparatus-state indicator 91 in a lights-out state. From the time point when the temperature of the sample reaches the initial temperature, the weight measurement section 3 measures the weight of the specimen sample and the reference sample moment by moment, and sends the measurement values to the data processor 5. Accordingly, the time point when the temperature of the sample reaches the initial temperature is substantially a measurement-start time point.

When the substantial measurement is started, i.e., the weight measurement is started, the display controller 7 allows the apparatus-state indicator 91 to flash. The apparatus-state indicator 91 continues flashing until the weight measurement pursuant to the measurement program is completed. When the weight measurement pursuant to the measurement program is completed, the analysis controller 6 causes the fan of the cooling section 2 to act for lowering the temperature of the heating furnace 1011 to a level near the room temperature. During the temperature lowering period, the display controller 7 keeps the apparatus-state indicator 91 in the lights-out state.

Through such an operation, the apparatus-state indicator 91 flashes only during a time period in which the weight data of a specimen sample and a reference sample are collected, in the TG/DTA simultaneous measurement apparatus according to the present embodiment. As previously mentioned, the apparatus-state indicator 91 has a horizontally-long shape, and the indication with flashing easily draws an individual's attention in comparison with an indication with simple lighting. Accordingly, it is easy even for an operator remote from the apparatus to some extent to visually recognize that the apparatus-state indicator 91 is flashing. When the apparatus-state indicator 91 flashes, it can be recognized that the measurement is in process. Therefore, an operator does not need to come close to the apparatus, or can pay careful attention to not touch the installation stand even if the operator is required to be close to the apparatus. Therefore, the disturbance can be prevented from affecting the weight data during the measurement.

Although the apparatus-state indicator 91 flashes only during the measurement of weight in the foregoing description, the apparatus-state indicator 91 can be lighted or flashed during a period other than the measurement period. The heating furnace 1011 may be heated to a level of 1500° C., for example, and thus the temperature of the housing (exterior cover) of the apparatus may be extremely high, though the apparatus is thermally insulated. Accordingly, it is important to notify an operator that the temperature of the apparatus is high, irrespective of the measurement being in process.

For example, if the temperature measured by the temperature measurement section 4 is more than or equal to a predetermined temperature, or the temperature is currently rising, it is preferable for the display controller 7 to cause the apparatus-state indicator 91 to be lighted or flashed. If the measurement is in process, the priority is given to the indication of the measurement in process. In other cases except for the measurement in process, the indication may be performed through other ways, such as continuous lighting, flashing in a cycle different from that for the measurement in process, and flashing with an indication color different from that for the measurement in process.

It is possible to allow the user to set the indication manner of the apparatus-state indicator 91 for the respective states of the apparatus, such as the state where the temperature is rising (except for the measurement in process), the state where the measurement is in process, and the state where the temperature is lowering after the completion of the measurement.

Furthermore, the notification by sound of a buzzer or the like may be simultaneously performed in addition to the indication in the apparatus-state indicator 91. The apparatus-state indicator 91 may be provided not only in front of the apparatus, but also in a plurality of positions including the top surface and side surfaces of the apparatus, whereby the measurement in process can be visually recognized from various directions.

Furthermore, an indicator unit which is separated from the apparatus, can communicate with the apparatus, and operates by synchronizing with the apparatus-state indicator 91, may be added. With this configuration, it is possible to visually recognize that the measurement is in process from a position at which the apparatus is not easily viewed.

Although the aforementioned embodiment is applied to the TG/DTA simultaneous measurement apparatus, it is apparent that the present invention is applicable to other thermal analyzers, such as a thermogravimetric apparatus, a thermomechanical analysis apparatus, and a differential scanning calorimetric analysis apparatus.

The aforementioned embodiment is an example of the present invention. It is apparent that any modification, change, or addition within the scope of the present invention is included in the scope of claims of the present application.

### [Various Aspects]

It is apparent for a person skilled in the art that the exemplary embodiments mentioned earlier are specific examples of the following aspects of the present invention.

(First aspect) An aspect of the thermal analyzer according to the present invention includes a heating section including a heating furnace in which a sample is contained; and a weight measurement section configured to measure a weight of the sample, the weight of the sample being measured by the weight measurement section while the sample is heated by the heating section. The thermal analyzer further includes a light emitting indicator that is provided in front of the exterior of the thermal analyzer, and includes a plurality of light emitting diode elements; an analysis controller configured to control heating by the heating section in accordance with a predetermined measurement program, and to acquire weight data of the sample from the weight measurement section in a predetermined time period; and an indication controller configured to drive the light emitting indicator to flash at least during a time period in which the weight data is acquired.

According to the thermal analyzer of the first aspect, it is easy for an operator remote from the apparatus to some extent to recognize that the measurement is in process. Therefore, the operator can be prevented from carelessly approaching the apparatus and touching the apparatus itself or an installation stand of the apparatus. As a result, defects of the weight measurement due to such disturbances can be reduced, and necessity of retry of the measurement can also be reduced, whereby the measurement efficiency can be improved. Furthermore, the lead time for the measurement can be shortened.

(Second aspect) In the thermal analyzer of the first aspect, the indication controller may be configured to control the light emitting indicator to flash or light during a time period in which a temperature is raised by the heating section or in a case when the temperature of the heating section is more than or equal to a predetermined value.

The thermal analyzer of the second aspect can notify an operator that the temperature of the apparatus is high even when the measurement is not carried out, so as to prevent the operator from carelessly approaching the apparatus or from touching the apparatus. Therefore, operator safety can be enhanced.

(Third aspect) The thermal analyzer according to the first aspect or the second aspect may further include an indication-state setting section configured to allow a user to set a relationship between an apparatus state and a light-emission/lights-out state of the light emitting indicator.

According to the thermal analyzer of the third aspect, the indication manner in the light emitting indicator can be changed so that an operator can be easily notified.

### REFERENCE SIGNS LIST

1 . . . Heating Section
2 . . . Cooling Section
3 . . . Weight Measurement Section
4 . . . Temperature Measurement Section
5 . . . Data Processor
6 . . . Analysis Controller
61 . . . Measurement Program Storage Section
7 . . . Display Controller
8 . . . Input Unit
9 . . . Display Unit
91 . . . Apparatus-State Indicator

1. A thermal analyzer comprising:
a heating section including a heating furnace in which a sample is contained; and
a weight measurement section configured to measure a weight of the sample,
the weight of the sample being measured by the weight measurement section while the sample is heated by the heating section;
a light emitting indicator that is provided in front of an exterior of the thermal analyzer, and includes a plurality of light emitting diode elements;
an analysis controller configured to control heating by the heating section in accordance with a predetermined measurement program, and to acquire weight data of the sample from the weight measurement section in a predetermined time period; and
an indication controller configured to drive the light emitting indicator to flash at least during a time period in which the weight data is acquired.

2. The thermal analyzer according to claim 1, wherein
the indication controller is configured to control the light emitting indicator to flash or light during a time period in which a temperature is raised by the heating section or in a case when the temperature of the heating section is more than or equal to a predetermined value.

3. The thermal analyzer according to claim 2, wherein
the display controller is configured to cause the light emitting indicator to flash in different manners between a time period during which the weight data is acquired and a time period other than the data-acquisition time period, including a time period in which the temperature is raised by the heating section or a case when the temperature of the heating section is more than or equal to the predetermined value.

4. The thermal analyzer according to claim 1, further comprising
an indication-state setting section configured to allow a user to set a relationship between an apparatus state and a light-emission/lights-out state of the light emitting indicator.

5. The thermal analyzer according to claim 2, further comprising
an indication-state setting section configured to allow a user to set a relationship between an apparatus state and a light-emission/lights-out state of the light emitting indicator.

6. The thermal analyzer according to claim 3, further comprising
an indication-state setting section configured to allow a user to set a relationship between an apparatus state and a light-emission/lights-out state of the light emitting indicator.
